(19) United States
(12) Patent Application Publication
(10) Pub. No.: US 2012/0158479 A1
(43) Pub. Date: Jun. 21, 2012

(54) METHODS AND DEVICES FOR APPLYING A SOCIAL NETWORK TO THE PRICE OF A PRODUCT

(76) Inventor: NETANEL RAISCH, Psagot (IL)

(21) Appl. No.: 13/308,585

(22) Filed: Dec. 1, 2011

Related U.S. Application Data
(60) Provisional application No. 61/423,225, filed on Dec. 15, 2010.
(60) Provisional application No. 61/429,222, filed on Jan. 3, 2011.

(51) Int. Cl. G06Q 30/02

(52) U.S. Cl. 705/14.19; 705/14.39; 705/26.4

(57) ABSTRACT

The invention discloses devices and methods for modifying the price of a product offered for sale, primarily on the internet. Specifically, the invention allows for a purchaser of the product and others to dynamically alter the price of the product. The price can go both down and up and downward price may be compensated by advertising revenue or other income sources.

### CROSS-REFERENCE TO RELATED APPLICATIONS

This Application claims the benefit of U.S. Provisional Application Nos. 61/423225, filed 15 Dec. 2010, entitled “Methods and Devices for Allowing a User to Determine the Price of a Product”, and 61/429222, filed 03 Jan. 2011, entitled “Methods and Devices for Applying a Social Network to the Price of a Product”, which are herein incorporated by reference.

### FIELD AND BACKGROUND OF THE INVENTION

The present invention, in some embodiments thereof, relates to methods for allowing a plurality of individuals to actively change the price of a product through certain activities, such as but not limited to watching a commercial or answering a questionnaire.

Social networks such as Facebook and MySpace have been extraordinary in their growth during the past several years. Facebook alone claims over 500 million unique users, each having tens or hundreds of contacts or “friends”. These arrangements offer unparalleled levels of communication and interaction between individuals and coworkers, friends and friends of friends. Online shopping has grown exponentially since the early days of internet.

Millions of transactions are performed by the hour, with sellers and buyers linked by computer, cell phone or other devices that allow for internet connectivity. Such transactions are done quickly and with a high level of security.

U.S. Patent Application No. 20100088148A1 to Presswala, et al. teaches techniques for optimizing shopping. In one aspect, purchase items are recommended to a user based on the total purchasing costs of the recommended purchase items. In one embodiment, the total purchase cost includes not just the price of the purchase item but also includes weighted costs based on non-price purchasing cost factors. In another aspect, data is maintained that represents social relationships between members of a network of users and purchase recommendations are made to a user based on the relatedness between the user, the item and the other members of the network. In yet another aspect, purchase recommendations are made based on the best time to purchase a purchase item. In another aspect, item retailers can offer purchase item incentives to users based on the identity of and information about the shopper to whom the incentive is offered including bundling incentives in a unified redemption code.

U.S. Pat. No. 7,720,722 to Ho, et al. describes a system that receives, at a network-based social platform, a request from a first user of the network-based social platform. The request is to add an item to a list associated with a second user of the network-based social platform. The list is for watching items offered for sale on a network-based marketplace. Next, the system determines whether the first user is authorized to add the item to the list associated with the second user based on relationship information that identifies a predetermined relationship between the first user and the second user on the network-based social platform. Finally, the system communicates the request to the network-based marketplace to add the item to the list associated with the second user.

U.S. Patent Application No. 2009/010685 to Raimbeault teaches a social networking interactive shopping system including a portable wireless user interface for use by a store customer when shopping. A merchant server is provided, the server having market survey, advertising, promotions, security, social networking services, web server capability, a quantitative prediction modeling system predicting behavior of the customer, a predictive response marketing/advertising system that targets advertising messages to the customer based on a predicted customer response to the advertising messages, and payment application software. The merchant server is capable of wired or wireless communication with the portable wireless user interface. A database is provided, and can be stored on site or off site. The database includes information associated with items for sale at the store, and is in operable communication with the merchant server. Using the portable wireless user interface, the store customer can purchase user selected store items thereby obviating necessity for travel through a store check-out line.

U.S. Patent Application No. 20100299266 to Catania, et al. describes a system and method for issuance, redemption, and reimbursement of digital incentives. A central database connected to the internet: enables customers to register unique customer registration information; is able to store this information and assign unique identifiers to it; and is accessible to incentives providers to make available digital incentives. Existing point-of-sale terminals: are authenticated to have access to the central database; have payment devices; are connected to the internet; and are provided with a message broker that facilitates communication with the central database. The customer redeems digital incentives at one of the existing point-of-sale terminals at the time of purchase by first presenting their unique identifier. The message broker routes the unique identifier to the central database which authenticates and validates the existing point-of-sale terminal, the customer's unique identifier, and the payment device. The central database then returns validated applicable digital incentives to the message broker which forwards the validated digital incentives for redemption.

U.S. Patent Application No. 20090198577 to Foreman et al. describes an invention related to an exclusive method, system and model of commerce created between a unique business entity that offers, publishes, and/or distributes any product and/or service through a subscription based membership program purchased by its consumers and the unique business entities' consumers who receive said products and/or services electronically or via mail. The unique business entities' consumers simultaneously operate their own home based business program utilizing a unique viral marketing campaign and cross promotion sales process created by the unique business entity.

The prior art generally describes means of online business but not methods by which a plurality of internet users may each contribute to reducing or increasing the final prices of a product through his or her actions.

### SUMMARY OF THE INVENTION

It is therefore a purpose of the present invention, in some embodiments, to describe methods and devices for allowing a user to partially determine the price of a product which he/she wishes to acquire.

The invention includes a website for the sale of at least one product, wherein a single action of a consumer on the website can either reduce or raise the price of the at least one product for another consumer.

In one aspect of the invention, the action involves expressing interest in buying the at least one product.

In another aspect of the invention, the action involves actually buying the at least one product.

In another aspect of the website, the expressing interest in the at least one product causes the price of the at least one product to decrease by a predetermined and advertised amount.

In another aspect of the website, the actually buying the at least one item causes the price of the at least one product to increase by a predetermined and advertised amount.

In another aspect of the website, the predetermined amount price increase for actually buying the at least one product is larger than the predetermined amount price decrease associated with expressing interest in the at least one product.

In another aspect of the website, the at least one product is a plurality of units of the at least one product.

The invention includes a method for applying game theory to a commercial website, including: providing a website for the sale of at least one product; displaying an initial price for the at least one product; allowing a consumer to express interest in purchasing the at least one product, wherein the price of the at least one product drops by a predetermined and advertised amount when the consumer expresses interest in purchasing the at least one product; allowing an in-opted consumer to purchase the at least one product, wherein the price of the at least one product increases by a predetermined and advertised amount when the consumer purchases the at least one product on the website; modifying the displayed price of the at least one product as a function of the number of consumers expressing interesting in the at least one product and the number of consumers actually purchasing the at least one product; displaying a current price of the at least one product as function of the modifying; and, allowing continued expression of interest and buying of the product.

In one aspect of the method, the dollar amount that the price of the at least one product drops when the consumer expresses interest in purchasing the at least one product is less than the increase in the price when the consumer actually purchases the at least one product.

In another aspect of the method, there is an additional step of suggesting to the consumer to view a commercial, wherein viewing of the commercial further reduces the price of the at least one product.

In another aspect of the method, the at least one product is a plurality of distinct products.

In another aspect of the method, the plurality of products is selected from the fields of consumer electronics, clothing, music, travel, recreation, transportation and entertainment.

The invention additionally includes a method for determining the optimal price of a product, including the following: providing a website where a consumer may purchase the product; assigning an initial price to the product; reducing the price of the product by a predetermined and advertised amount for each consumer that expresses interest on the website for purchasing the product; selling the product when a consumer commences a purchase of the product on the website; raising the price of the product by a predetermined and advertised amount with the purchase of the product; modifying the price of the product, wherein each purchase of the product raises the price of the product, while expression of interest in the product by new consumers leads to a reduction of the price of the product; and, selling additional units of the product, each unit sold at a current price determined by initial price, number of people expressing interesting in the product, and number of people actually having bought the product.

In one aspect of the method, a plurality of consumers can purchase a plurality of units of the product.

In another aspect of the method, the predetermined and advertised amount in price reduction is ten cents.

In another aspect of the method, the predetermined and advertised amount in price increase is $1.

In another aspect of the method, there is an additional step of suggesting to the consumer to watch a video commercial in exchange for further reducing the price of the product.

In another aspect of the method, the commercial is related to the product.

In another aspect of the method, the product is a consumer product.

In another aspect of the method, there is an additional step of alerting a consumer as to the price of the product.

In another aspect of the method, the alert is delivered to the consumer by phone, SMS, instant messaging, electronic mail or other form of communication.

In another aspect of the method, the actions are selected from the activities of watching advertisements, responding to questions, joining a group, providing information, rating products, going to one or a plurality of websites, performing activities on one or a plurality of websites, downloading or uploading information, filling out questionnaires, or doing a combination of different activities

The invention includes a method for providing a private sale of a product, including the following: allowing a user to choose a product which he/she wishes to purchase; beginning a sale of the product to the user at a predetermined price for the product; providing instructions to the user as to how he/she can reduce the price of the product through his/her actions and/or the actions of others; allowing the user and the others to perform the actions, wherein the performance of the actions reduces the price of the product; and, selling the product to the user either at the end of a predetermined period of time or at a time when the user indicates that he/she wishes to purchase the product at a known current price.

In one aspect of the method, the instructions include viewing of an online advertisement or responding to an online questionnaire.

In another aspect of the method, the product is selected from the fields of consumer electronics, clothing, music, travel, recreation, transportation, food and entertainment.

In another aspect of the method, the private sale is conducted in conjunction with a social network website.

In another aspect of the method, people associated with the user follow the instructions in order to reduce the price of the product.

In another aspect of the method, the price of the product reaches zero dollars.

In another aspect of the method, the private sale is accessible only to the user and to individuals associated with the user.

In another aspect of the method, the product is a plurality of identical or different products.

In another aspect of the method, the private sale is a plurality of private sales.

The invention additionally includes a method for using a social network to reduce the price of a product, including: providing a website where the product can be purchased; allowing a user of the website to purchase the product; informing the user that the website will not charge the user for the purchase of the product for a given period of time; instructing the user as to activities that, if performed, would allow for a lowering of the price of the product, the more activities performed the greater the discount in the price of the product; allowing the user to perform the activities and encourage his/her friends and acquaintances to perform the same the activities; and, charging the user for the product after the period of time, the final price being the original price for the product less any amounts accrued through the performance of the activities.

In one aspect of the method, the activities include viewing of an advertisement, providing personal information, filling out a questionnaire, rating a product, recruiting new users, and performing a specific task.

In another aspect of the method, the friends and acquaintances are associated with the user via a social network.

The invention additionally includes a method for determining the optimal price of a product, including the following: providing a website where a consumer may purchase the product; assigning an initial price to the product; reducing the price of the product by a predetermined and advertised amount for each consumer that expresses interest on the website for purchasing the product; selling the product when a consumer commences a purchase of the product on the website; raising the price of the product by a predetermined and advertised amount with the purchase of the product; modifying the price of the product, wherein each purchase of the product raises the price of the product, while expression of interest in the product by new consumers leads to a reduction of the price of the product; selling additional units of the product, each unit sold at a current price determined by initial price, number of people expressing interesting in the product, and number of people actually having bought the product; and, halting sales of the product when profit per unit falls to a predetermined cutoff level. returning price of product to a value above cost when profit per unit falls to a predetermined cutoff level.

In one aspect of the method, a plurality of consumers can purchase a plurality of units of the product.

In another aspect of the method, the predetermined cutoff level is $50 per unit.

In another aspect of the method, the predetermined and advertised amount raise in price is $10.

In another aspect of the method, there is an additional step of suggesting to the consumer to watch a video commercial in exchange for further reducing the price of the product.

In another aspect of the method, the commercial is related to the product.

In another aspect of the method, the product is a consumer product.

In another aspect of the method, there is an additional step of alerting a consumer as to the price of the product.

In another aspect of the method, the alert is delivered to the consumer by phone, SMS, instant messaging, electronic mail or other form of communication.

The invention additionally includes a method for determining the optimal price of a product, including the following: providing a website where a consumer may purchase the product; assigning an initial price to the product; reducing the price of the product by a predetermined and advertised amount for each consumer that expresses interest on the website for purchasing the product; selling the product when a consumer commences a purchase of the product on the website; raising the price of the product by a predetermined and advertised amount with the purchase of the product; modifying the price of the product, wherein each purchase of the product raises the price of the product, while expression of interest in the product by new consumers leads to a reduction of the price of the product; selling additional units of the product, each unit sold at a current price determined by initial price, number of people expressing interesting in the product, and number of people actually having bought the product; and, returning price of product to a value above cost of product when profit per unit falls to a predetermined cutoff level.

Unless otherwise defined, all technical and/or scientific terms used herein have the same meaning as commonly understood by one of ordinary skill in the art to which the invention pertains. “Product”, “consumer product”, website”, “internet”, social network”, “price” “commercial”, “survey”, “SMS”, “email”, “instant messaging” and “user” may have their normal meanings as understood in the relevant business, electronic, and other arts. “Expressing interest” in a product may mean that an individual or user expresses to a website that he/she may in the future purchase a given product or item. The individual or user may be asked to provide an email address, cell phone number or other identifying feature. “Opt in” and “opting in” may generally refer to someone expressing interest in purchasing a specific product from a website. An “in-opted consumer” refers to a consumer who has performed an opt-in action for a specific product, one that he/she apparently is interested in purchasing. A “private sale” may refer to a sale of a product to an individual, wherein the individual and others may act in a manner to reduce the price of the product. An “activity” may be an action whose performance may lead to the decrease in the price of a product. In case of conflict, the patent specification, including definitions, will control. In addition, the materials, methods, and examples are illustrative only and are not intended to be necessarily limiting. A “unit” may refer to a single copy of a product.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced. It is noted that similar elements in various drawings will generally have the same number, advanced by the appropriate multiple of 100.

In the drawings:

FIG. 1 is a schematic representation of an embodiment of a private sale according to the present invention;

FIG. 2 is a schematic representation of an example of a private sale;

FIG. 3 shows a schematic representation of a second embodiment of the present invention;

FIG. 4 is a schematic representation of an example of the second embodiment;

FIG. 5 is a shows a schematic representation of a third embodiment of the present invention;

FIG. 6 is a flowchart of a method associated with the present invention; and,

FIG. 7 is a flowchart of an alternative method associated with the present invention.

FIGS. 8-10 show examples related to the embodiment of the invention associated with FIG. 7.

### DESCRIPTION OF SPECIFIC EMBODIMENTS OF THE INVENTION

The present invention, in some embodiments thereof, relates to methods and devices for allowing at least one consumer to reduce the price of a product through either expressing interesting in purchasing said product and/or fulfilling tasks requested of said user such as but not limited to viewing a video, performing a task, or completing a questionnaire.

### First Embodiment

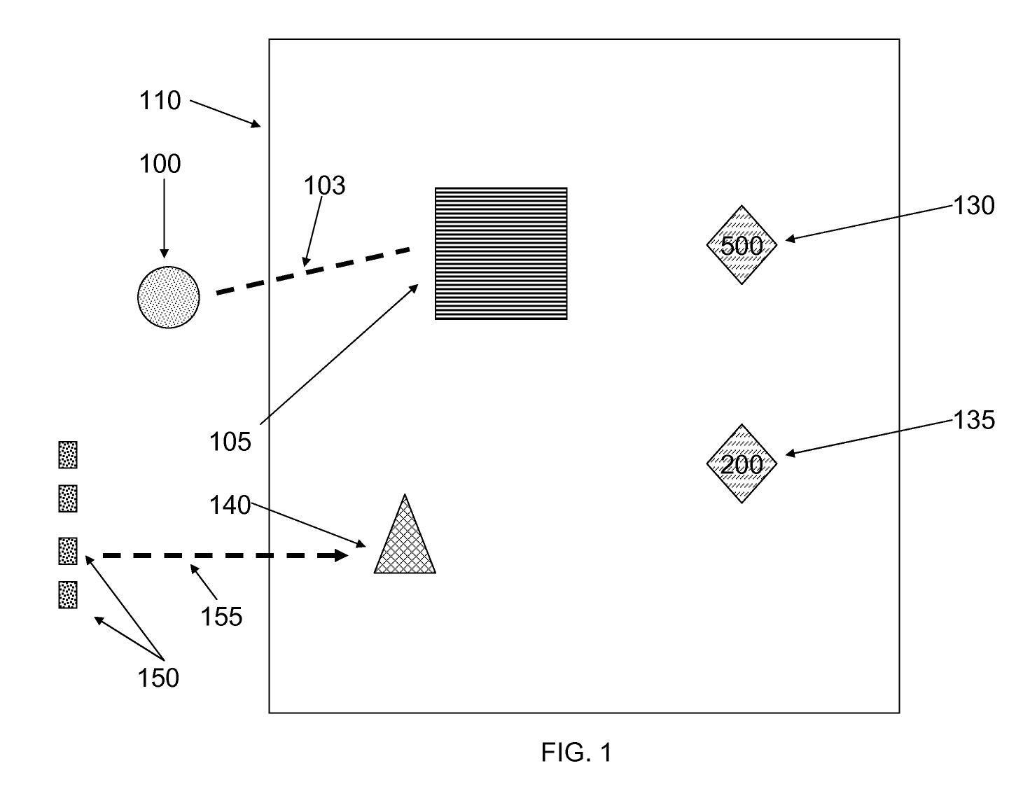

Attention is turned to FIG. 1 which shows a schematic view of an embodiment of the present invention. This embodiment may be referred to as a “private sale”, as an internet user or a member of a social network can arrange with an internet merchant to purchase an item in a manner that is independent of standard website business practice, as herewith explained. A user 100 identifies 103 a product 105 on a website 110 and wishes to acquire said product 105. The product 105 has an associated advertised price 130 which is determined by the website 110. The user 100 can notify the website 110 that he/she wishes to initiate a “private sale” wherein the user 110 may be the only person in the private sale who can purchase the product 105. The website can set up a private sale of said product 105 or a group of products (not shown) for said user 100. The website 110 will provide instructions to said user 100 as to how he/she can reduce the advertised price 130 of the product 105. Instructions may include activities such as watching an advertisement 140, the advertisement optionally being related to the product 105 or the company that manufactures the product 105, filling out a questionnaire, performing a web-based activity, following a link to another website, or providing some information (not shown). User 100 optionally can contact friends, acquaintances, or others 150 either directly or through the website 110 and request from said friends, acquaintances, or others 150 their help in reducing the advertised price 130 of the product 105. Friends, acquaintances, or others 150 can for example watch 155 an advertisement 140, with each view of the advertisement 140 directly lowering the advertised price 130 of the product 105. Each view or each unique viewer can reduce the price of the product 105 by a predetermined and optionally advertised amount. The website can optionally verify that a real person has viewed the commercial and may limit the number of times a unique individual can watch 155 the commercial 140. Friends, acquaintances, or others 150 may be provided a plurality of activities such as answering questions or watching 155 an online commercial 140, each performance of an activity reducing the price of the product 105. After a predetermined period of time, or when product 105 dynamic price 135 reaches zero or when user 100 decides to buy, product 105 is purchased by user 100 from the website 110 or a related site (not shown). The “dynamic price” is the actual price of the product, it being the advertised price 130 less any monies deducted from the activities of the user 100 and/or his/her friends, acquaintances or other 150 as described above. Website 110 may run a plurality of private sales on a plurality of products at any one time.

The rationale for the website 110 being willing to reduce the advertised price 130 of product 105 may include payment from advertiser (not shown) for each view of said commercial 140, wherein the payment for each view is greater than or equal to the price reduction given to product 105 for each said view. Thus, the website 110 either makes money or minimally does not lose money, while user 100 gets product 105 at a significant discount over advertised price 130.

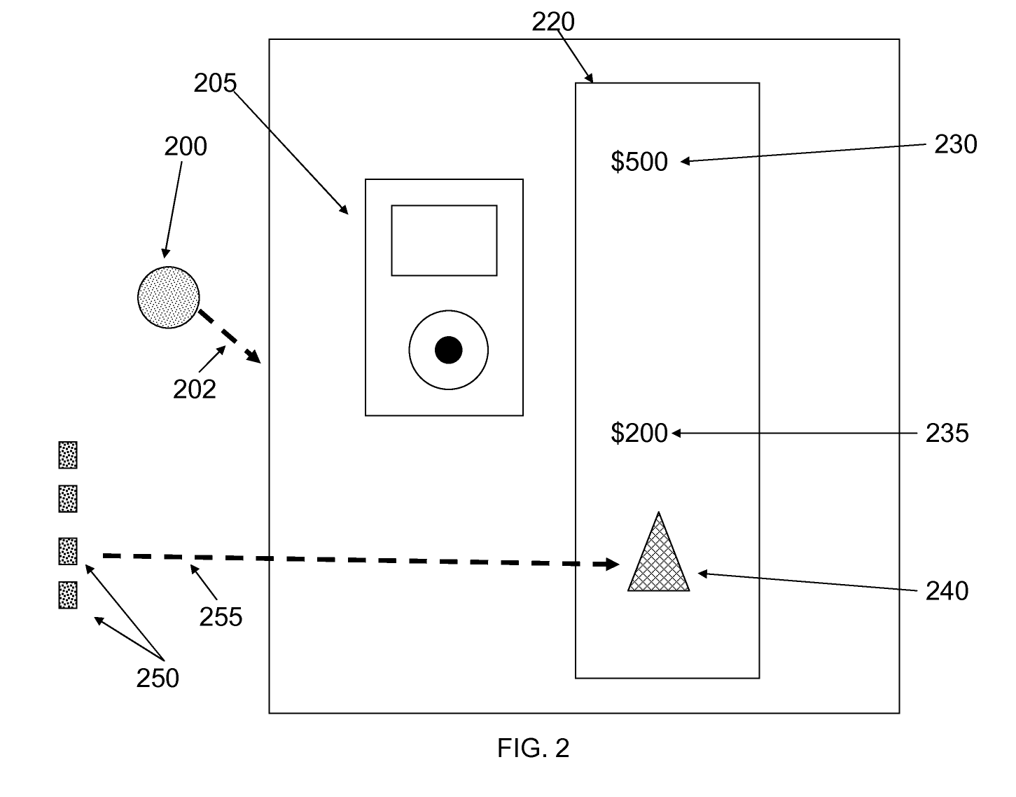

Attention is now turned to FIG. 2 which offers an example of the first embodiment in practice. A music player 205 is for sale for an advertised price 230 of $500. A user 200 informs 202 the website 210 selling the music player 205 that she wishes to enter a private sale. Website 210 sets the music player 205 into an optional private sale window 220 and instructs user 200 that for every view of a video advertisement 240 from the manufacturer of the music player 205, the website 210 will reduce the price of the music player 205 by 50 cents. Each unique visitor to the website may watch the video up to four times during the private sale; thus each unique visitor to the private sale (which may be advertised by the website 210 but will most generally be advertised by the user 200) may reduce the price of the music player 205 by a maximum of $2. The website 210 agrees to this arrangement as each viewing of the video advertisement 240 results in it being paid $1 by the manufacturer of the music player 205, for example. The user contacts her friends, relatives, and coworkers via a social network website, email, SMS, instant messaging and other means in order to encourage them watch 255 the video advertisement 240 at no cost to them but in the process reduce the advertised price 230 of the music player 205 for her. In total, 600 views of the video advertisement 240 are performed by 200 friends, acquaintances or others 250 and the price of the music player 205 is reduced to a dynamic price 235 of $200. The user 200 purchases the music player 205 for $200. The website 210 receives the $200 from user 200 as well as $600 from the manufacturer of the music player 205, for a gross of $800 for the private sale. A regular online sale of music player 205 would have grossed only $500, the advertised price 230 of the music player 205.

In the end, the website 210 owners are better off as they made more money than they could have through a standard sale. User 200 is better off as she purchased the music player 205 for less than half of its advertised price 230. Manufacturer of the music player 205 is better off as it received 600 confirmed views of its commercial, all from friends and associates of user 200, many of them probably also in products from said manufacturer. And finally, the friends and acquaintances 250 of user 200 are better off for having helped her acquire the product of her dreams at such a reduced dynamic price 235. A window (not shown) on user's 200 computer, cell phone or other device could give real-time information on the private sale such as the dynamic price 235 of product 205.

A private sale as herewith described may be performed on any platform that has connectivity to the internet—computers, cell phones, tablet computers, etc. A private sale could also be performed by a more traditional or “brick and mortar” store or the like, wherein sale of a product or a group of products is limited to a single customer or a small group of customers, and others can drive down price by following instructions provided by the seller.

A private sale may also include a tracking mechanism to relate how much each friend, acquaintance or the like has helped in lowering price of product. A ranking or reward system may also be implemented to encourage helping others to lower prices of desired products. Friends could be listed at Facebook for example in order of their assistance in helping to purchase items. Rankings could lead to awards, the more a person helps his/her friends, the greater the discount that this person might receive in future purchases.

### Second Embodiment

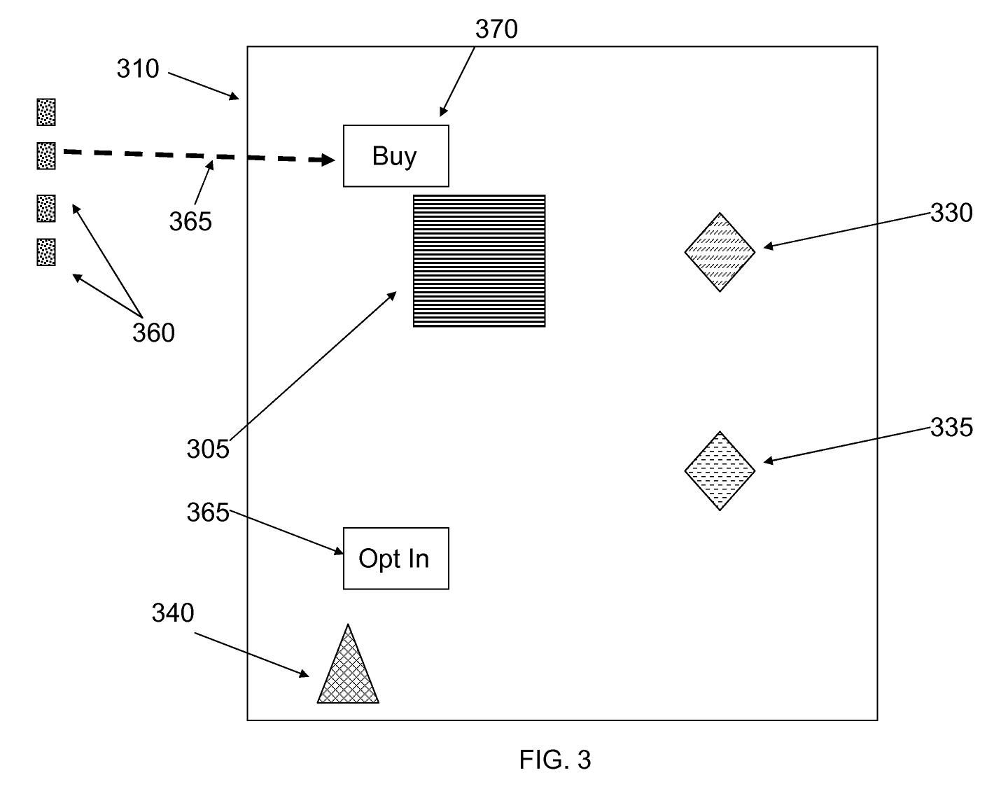

Attention is now turned to FIG. 3 which is shows a second embodiment of the present invention. In this embodiment, game theory is used to determine the price of a product 305. A web-based business offers said product 305 for sale. Users 360 who go to the website 310 can “opt in” for the sale of the product 305 by depressing (digitally) the “Opt In” button 365. By “opting in”, a user identifies himself/herself as a potential buyer of the product 305. The users are generally registered users who may have previously provided some type of identifying information—possibly a password, cell phone number or other piece of information that can be used to uniquely identify a user as well as allow for sending information to said user. A user's opting in automatically drives down the price of product 305 by a predetermined and generally known amount (not shown). The more people who opt in on a given product 305, the more the price of the product 305 drops. Individuals interested in buying product 305 would obviously hope that as many people as possible opt in to the purchase of product 305, as each new user opting in, drives the price down further. The price drop may generally be smaller than an advertisement such as a banner ad that may appear on the website 310 page. Thus, the price decrease is again smaller than the revenue increase from advertising or other source.

Throughout the sales period (which may be time-limited or open-ended), the product 305 maintains a dynamic price 335 which reflects the advertised price 330 less an amount that reflects the number of people who have opted into the purchase of the product 305. The dynamic price 335 could go to zero if enough people opted in and possibly did additional acts (such as viewing an advertisement 340) that also bring down the price of the product 305. Thus, price of product 305 can be between the advertised price 330 and zero. This is an important distinction between the present invention and sales as performed by group sales websites like Groupon (www.groupon.com). In the latter case, a certain number of people must express interest in buying a product; when that number is reached, the price drops in a binary fashion from an original price to a discounted price. Additionally, Groupon chooses which products to offer for discount, whereas in the present invention, users 360 choose which product 305 to buy, and there can be a plurality of products for sale (not shown). In the present invention, each individual who opts into a sale of a product 305 individually reduces the price 330 and may participate in activities that reduce the price 335 by more than the opt-in reduction. In the present invention, the final price of product 305 is not known from the start.

When one of the users 360 decides to purchase the product, he/she activates 365 a “Buy” button 370 on the website 310 which then fixes the price for that purchase at the dynamic price 335 for that moment. Immediately after the purchase, the dynamic price 335 goes up by a fixed and optionally advertised amount—in order to reflect that the dynamic price 335 had reached a point where the product 305 was successfully sold to one of the opted-in users 360. Only opted-in users 360 can buy the product 305 at the dynamic price 335. The website 310 may optionally contact all of those users 360 who opted into the purchase of product 305 so as to alert them that the dynamic price 335 of product 305 has risen. The website 310 alternatively can alert those who have opted in at any time during the sale of product 305 as to the dynamic price 335 status of the product 305. Such information can be provided by SMS, email, phone application, instant messaging, a dedicated computer window, social network account or by other means.

After the dynamic price 335 of product has gone up due to a first purchase, the dynamic price 335 continues to change. With each purchase of product 505, the price goes up, while new opt in users and/or additional price-reducing activities such as filling in questionnaires, watching advertisements 340 or performing other activities by opted-in users 360 can reduce price. Individuals who have opted in can each decide when to purchase product 305 if at all. There is no obligation to buy product and there is no prepayment and generally credit card information will not be required to opt-in to a sale.

The embodiment herewith described embodies in some ways game theory as applied to internet shopping. Users join a sale and watch the price of the product decrease as a function of more users expressing interest in the product and performing activities that are known to reduce the price of product. There will come a price level when a user or a group of users will decide that a purchase is in order. Purchase of product 305 begins to drive the dynamic price 335 back up towards the advertised price 330. Each user much then decide if to purchase, if to let the price to continue to rise or to wait for more opt-in users 360 or price-reducing activities to occur. The website 310 attracts many users 360 through the ability to drive down advertised price 330 and makes up for any lost revenue in the dynamic price 335 of product through advertisements 340 or the like as watched or performed by users.

It is understood, the many sales may be run in parallel, the sales being of the same or different products. One may be involved in multiple sales of the same product, looking for the best price between the multiple sales of the product.

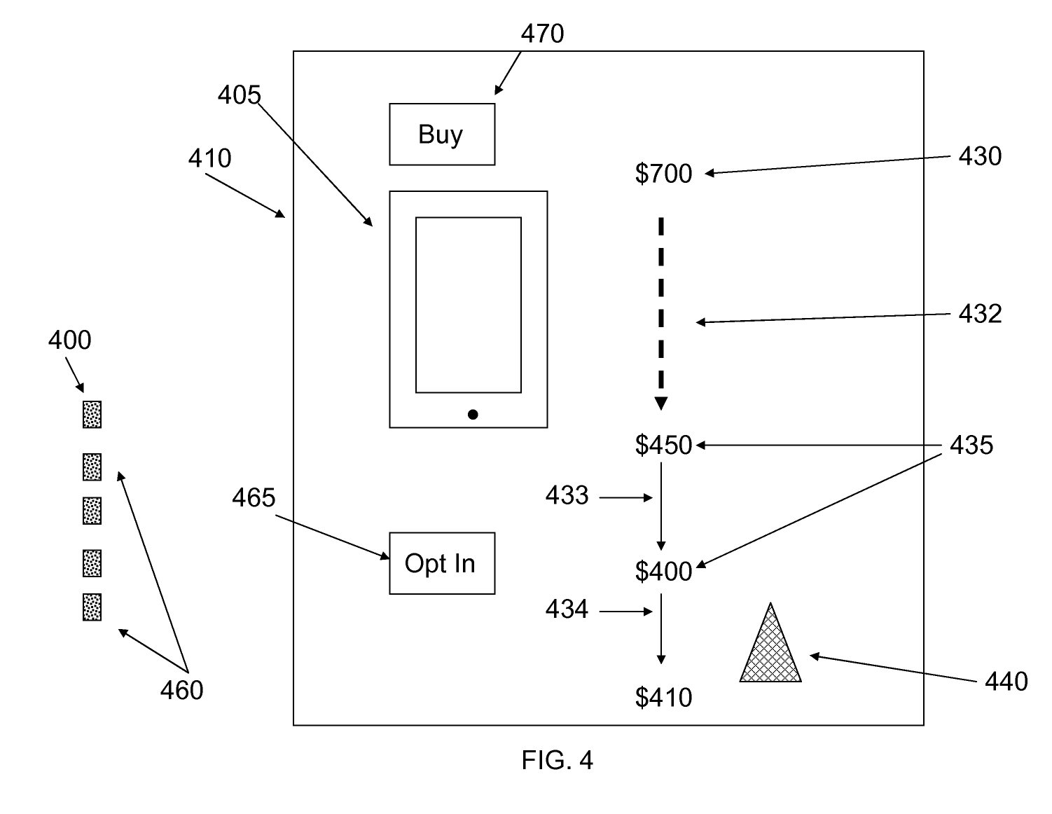

Attention is turned to FIG. 4 which gives an example of the embodiment herewith described. A website 410 advertises a tablet computer 405 for $700, the advertised price 430. The website 410 explains that anyone “opting in” to the sale of the tablet computer 405 will cause the price of the tablet computer 405 to drop by 25 cents, the website 410 receiving 50 cents for each banner ad from the manufacturer of the tablet computer 405. Opting in may be performed by depressing an “Opt In” button 465 on the website 410. There is no limit to the number of copies of the tablet computer 405 that the website 410 is able to sell (though they will generally sold one at a time).

One thousand individuals 460, identified by unique cell phone numbers to which a confirmation code is sent by SMS (not shown), opt in to the sale of the tablet computer 405. The advertised price 430 of the tablet computer is reduced 432 by $250 (1000×$0.25) to a dynamic price 435 of $450. Additionally, 100 of those one thousand individuals 460 who opted in perform an activity, namely each fills out a questionnaire 440 related to the quality of products from the manufacturer of the tablet computer 405 (or potentially any other tablet computer manufacturer). Each questionnaire filled out additionally reduces the price 435 of the tablet computer 405 by an additional 50 cents. Thus, the dynamic price 435 of the tablet computer 405 is further reduced 433 to $400. At this dynamic price, an opted-in user 400 pushes the “Buy” button 470 on the website 410. That user 400 purchases the tablet computer 405 for $400, but the dynamic price 435 jumps 434 $10 to $410. This jump in dynamic price 435 reflects the fact that the tablet computer reached a level ($400) that is attractive for purchase by at least one user 400. With the increase in dynamic price 435 of the tablet computer 405, others may choose to buy the tablet computer 405 rather than risk additional increases in dynamic price 435. They dynamic price when going up may be kept at a new, higher price for a given period of time or may increase with each purchase of the tablet computer 405. With each additional purchase, the dynamic price 435 of the tablet computer rises generally by a fixed amount ($10 in this example), while with each additional opt in or each view of the advertisement 440, the dynamic price 435 of the product drops. This automatic process continues either until a predetermined time, quantity runs out on the product, users stop buying the tablet computer 405, or a predetermined profit per unit sold minimum has been reached.

A product (FIG. 1, 105) for the present invention may be anything that can be sold or bartered, including but not limited to food, cosmetics, cars, travel, tickets, consumer products, electronics, computer, music players, tablet computers, clothes, furnishings, shoes, music, books, appliances, homes, real estate, stocks, bonds, antiques, valuables, jewelry, vacations, transportation, perfume, animals, and personal items.

Activities that could be asked of individuals in order to bring down the price of a product 105 could include but are no way limited to watching advertisements, responding to questions, joining a group, providing information, rating products, going to one or a plurality of websites, performing activities on one or a plurality of websites, downloading or uploading information, filling out questionnaires, or doing a combination of different activities. The website 110 may verify completion of one or a plurality of activities by any means, and the website 110 can use appropriate security measures to guarantee that those who opt-in and those who perform activities related to reducing the cost of product 105 are real people and not just computers acting as users or members. Such measures might include password protection or entry of a code sent by SMS to a cell phone of user, for example.

### Third Embodiment

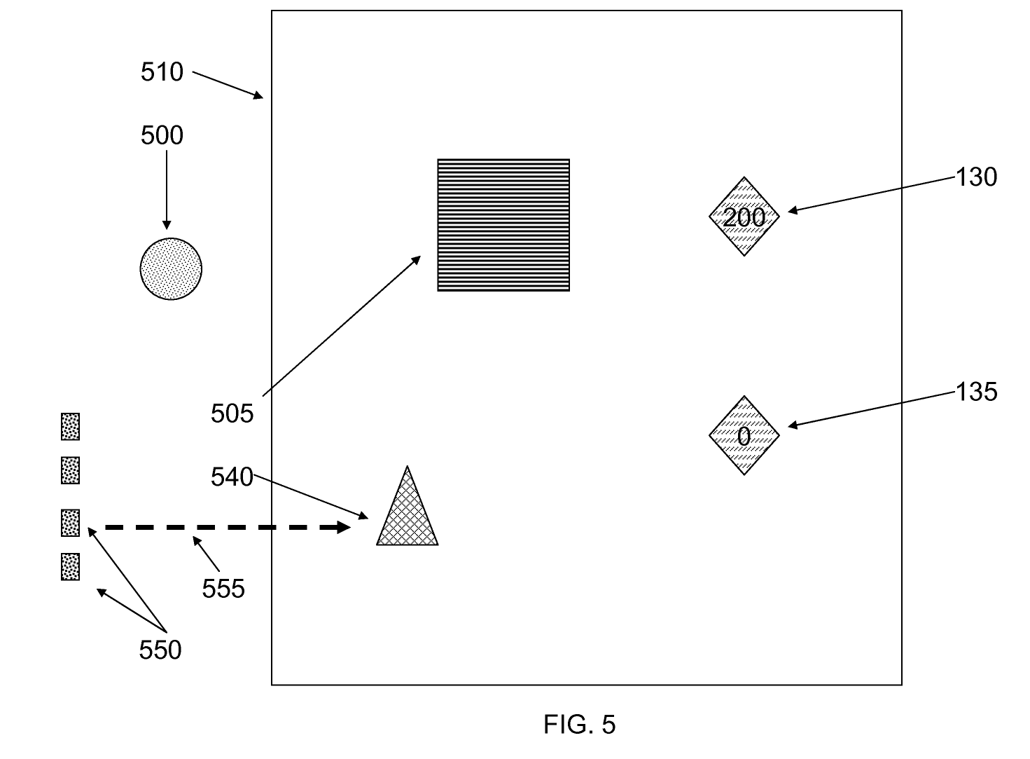

Attention is turned to FIG. 5 which shows a schematic representation of an embodiment of the present invention. A user 500 purchases a product 505 on a website 510. The website 510 instructs the user 500 that he/she can pay for the product 505 after a predetermined period of time; during that time, user 500 can turn to friends, acquaintances, and others 550 that they should watch 555 an advertisement 540 or perform another predetermined activity (not shown), each such viewing or activity reducing the price of the product 505 to be paid by user 500. After the predetermined period of time has elapsed, the website 510 charges the user 500 according to the advertised price 530 minus any monies garnered as a function of friends, acquaintances, and others 550 performing activities in support of a price reduction for user 500. In this embodiment, as in those before it, the dynamic price 535 could reach 0 if enough activities are performed during the time period in question. The website 510 would make up for the lost payment on product 505 by advertising or other revenues related to the activities performed by user 500 and/or friends, acquaintances, or others 550.

This embodiment is ideal for those who have many “friends” on sites like Facebook and MySpace. After buying product 505, user 500 can turn to his/her friends and ask for their help in reducing the dynamic price 535 to as low a value as is possible in the time given. This embodiment is by no means limited to social network applications.

It is understood that the embodiments of the present invention can be practiced in a stand-alone manner or in conjunction with a website, a retailer or a social network. Some of the embodiments of the present invention have application to “brick and mortar” stores in place of a website.

### Fourth Embodiment

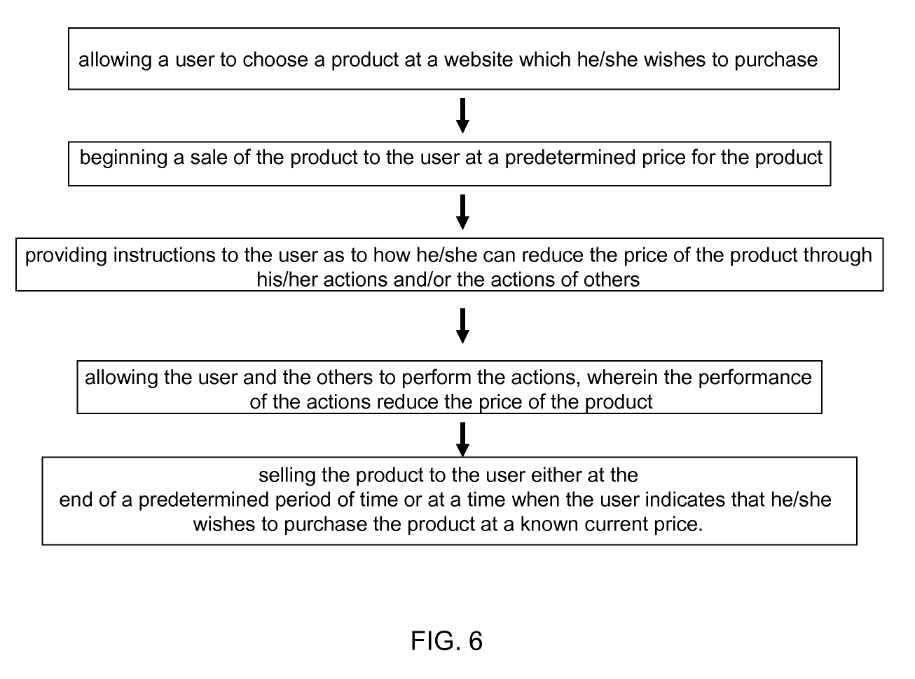

Attention is turned to FIG. 6, which shows a method of the present invention. This method is associated with a “private sale” arrangement between a website and a user or member of the website. The method includes the following steps: allowing a user to choose a product at a website which he/she wishes to purchase; beginning a sale of the product to the user at a predetermined price for the product; providing instructions to the user as to how he/she can reduce the price of the product through his/her actions and/or the actions of others; allowing the user and the others to perform the actions, wherein the performance of the actions reduce the price of the product; and, selling the product to the user either at the end of a predetermined period of time or at a time when the user indicates that he/she wishes to purchase the product at a known current price.

### Fifth Embodiment

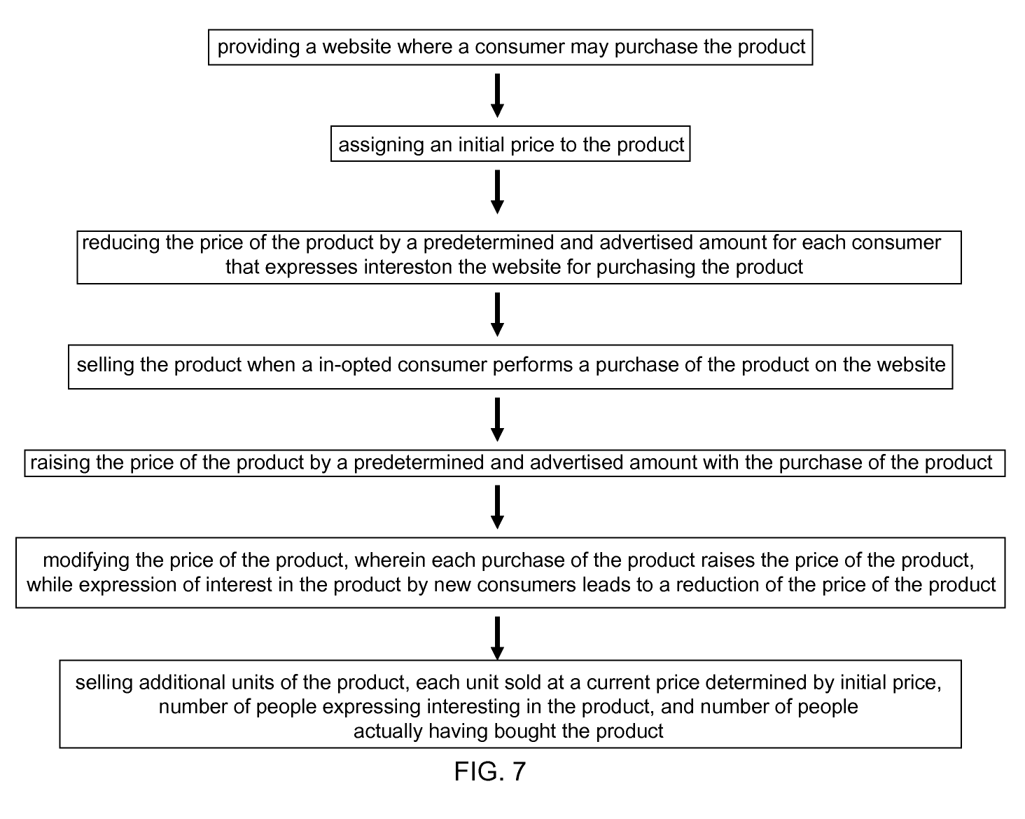

Attention is turned to FIG. 7 which shows a method associated with the instant invention. The method relates to an “opt-in” embodiment for reducing the price of a product. The method includes the following: providing a website where a consumer may purchase the product; assigning an initial price to the product; reducing the price of the product by a predetermined and advertised amount for each consumer that expresses interest on the website for purchasing the product; selling the product when a in-opted consumer performs a purchase of the product on the website; raising the price of the product by a predetermined and advertised amount with the purchase of the product; modifying the price of the product, wherein each purchase of the product raises the price of the product, while expression of interest in the product by new consumers leads to a reduction of the price of the product; and, selling additional units of the product, each unit sold at a current price determined by initial price, number of people expressing interesting in the product, and number of people actually having bought the product.

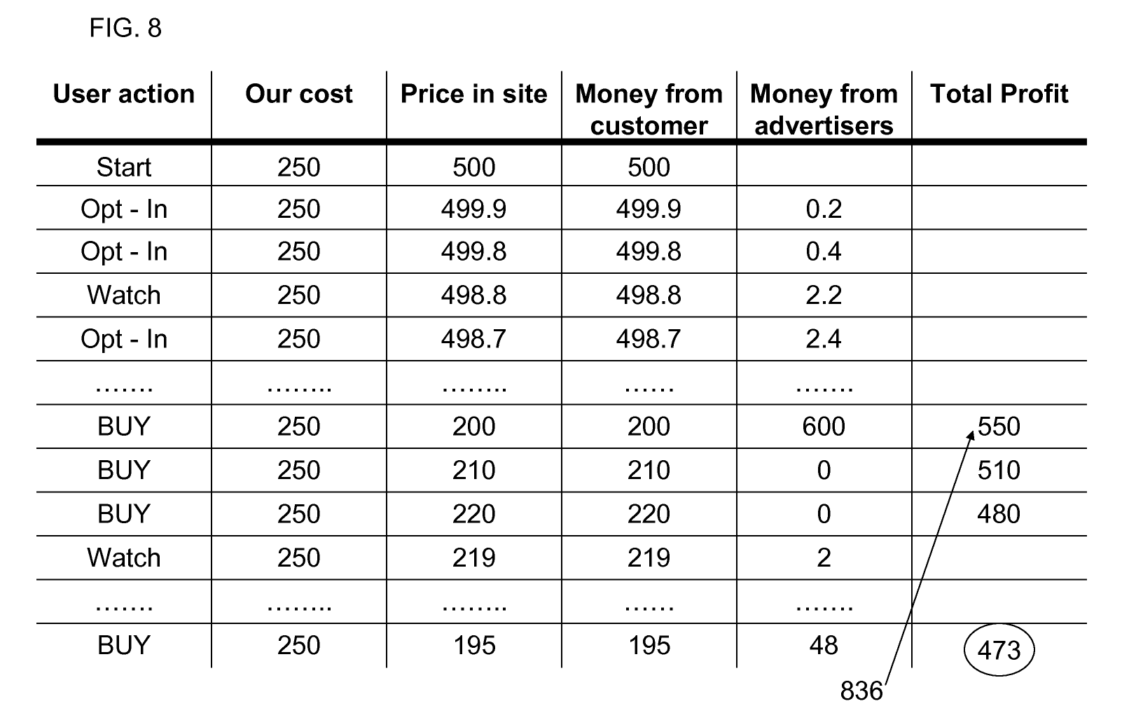

One potential challenge with the present embodiment concerns the risk of losing money. Specifically, the advertising and similar income brought in by through reducing the price is greatest per unit with the first sale. FIGS. 8-10 show examples from the present embodiment in which opt-in reduces the price of product by 10 cents (the website making 20 cents for each banner ad presented when a person executes a buy-in) and potentially $1 for viewing an advertisement (website making $2/advertisement), while a purchase of the product raises the price $10. These figures are to be read from top to bottom and a series of dots represents continued activities not shown for reasons of brevity. As shown in FIG. 8, the greatest profit--$550-occurs 836 with the sale of the first unit at a price of $200. The website net is $600 in advertising revenue and $200 paid by buyer less $250, the cost of the product for a total of $550 of profit. With the sale of the second unit, net profit drops to $510, which comes to $255 profit per unit. One could stop the sale with the first product to maximize profit or make a lowest allowable price which may or may not be the purchase price, but then there is a risk that people will stop coming to the site if only one or a very few number of users can buy the product or if there is a defined limit to lower unit price. Instead, additional products are sold, at higher prices but with reduced overall profit, as the example in FIG. 8 has sales occurring below the product cost to the website ($250). As shown in FIG. 8, the final profit for the sale of four units is $473 (shown in circle).

The invention also includes a program that controls a sale of a product and monitors changes in price as per opt-in, but and other actions. The program may stop a sale when the net profit per unit reaches a predetermined lower level so as to prevent losses or unacceptable profit levels. Alternatively, the program can stop price reduction at a predetermined price level and/or stop a sale for other reasons that include but are not limited to and end of stock for the product. Alternatively still, instead of stopping the sale completely, the program can raise the price by more than the $10 and even return the price to a significantly higher level, such as $250 or $350 (base price plus $100 of profit/unit). If the sale is stopped, it may be restarted later at the original price in order to begin the process again.

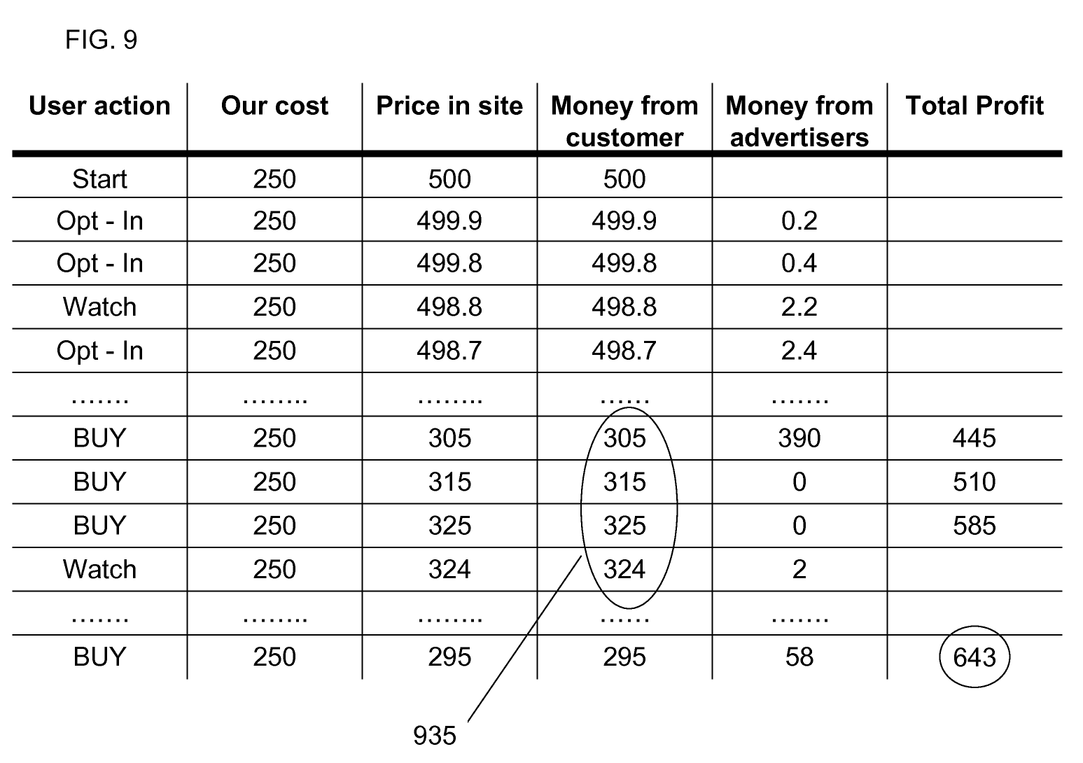

Attention is turned to FIG. 9, where the variable prices (935, shown in ellipse) for sold units are all higher than the $250 unit price paid by the website for the product. The net profit (shown in circle) of $643 for four units sold yields more than $160 profit per unit, while buyers saved nearly $200 each on the advertised purchase price. In this example, the “Buy” button (not shown) was pressed well above the cost of the product ($250) and subsequent units of product were additionally purchased at profitable prices.

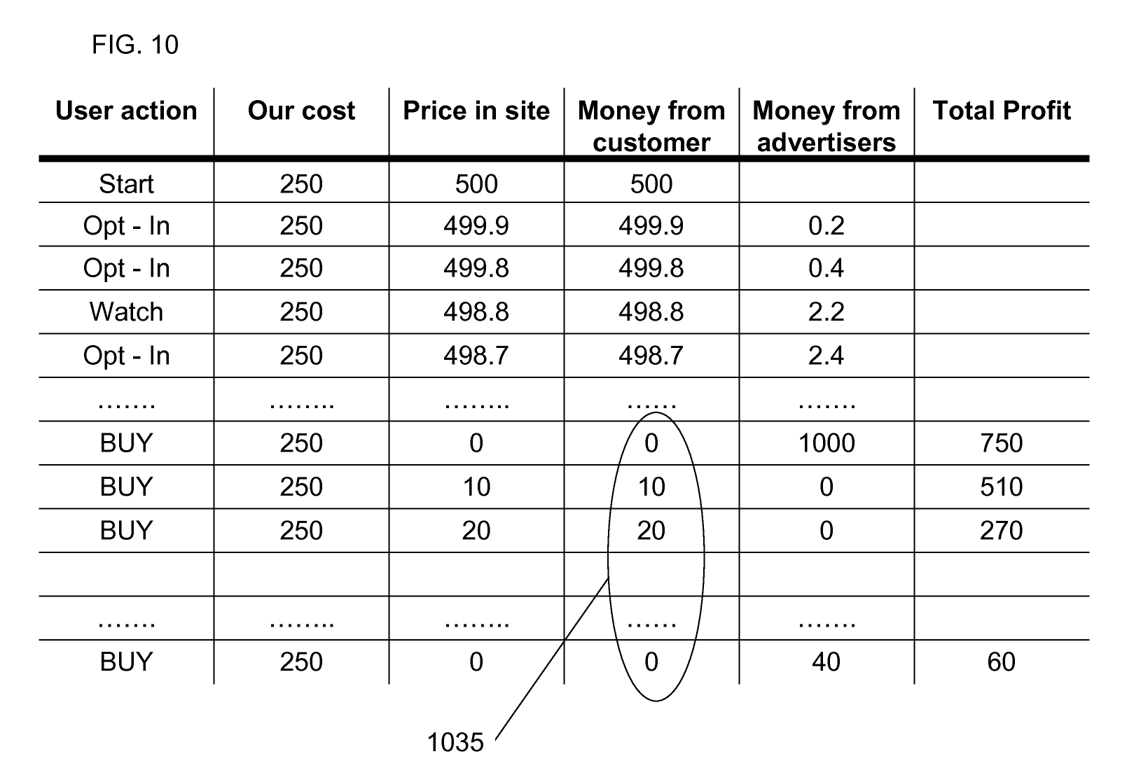

Attention is turned to FIG. 10, which shows an example of the present embodiment of the invention in which the dynamic price 1035 twice reaches zero. Two units are sold at this price and the net profit for sale of four units is $60. While the profit is low, the ability to drive down prices to nothing will allow for a large user base, which means more overall sales as well as higher advertising rates.

It is expected that during the life of a patent maturing from this application variable internet-based price-modification strategies will be developed and the scope of the term of the invention is intended to include all such new technologies a priori. As used herein the term “about” refers to ±10%.

The terms “comprises”, “comprising”, “includes”, “including”, “having” and their conjugates mean “including but not limited to”.

The term “consisting of means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. The present invention may be part of a social-network website or part of a commercial or retail website. Users could be potentially ranked according to their activity, either in purchasing products and/or in participating in activities that reduce product prices. Higher ranked users may receive bigger discounts or may enter a higher category such as “gold”, “silver” or similar categories to rank the web activity of users as it relates to the instant invention.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following example.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A website for the sale of at least one product, wherein a single action of a consumer on said website can either reduce or raise the price of said at least one product for another consumer.

2. The website according to claim 1, wherein said action involves expressing interest in buying said at least one product.

3. The website according to claim 1, wherein said action involves actually buying said at least one product.

4. The website according to claim 2, wherein said expressing interest in said at least one product causes the price of said at least one product to decrease by a predetermined and advertised amount.

5. The website according to claim 3, wherein said actually buying said at least one item causes the price of said at least one product to increase by a predetermined and advertised amount.

6. The website according to claim 5, wherein said predetermined amount price increase for actually buying said at least one product is larger than said predetermined amount price decrease associated with expressing interest in said at least one product.

7. The website according to claim 1, wherein said at least one product is a plurality of units of said at least one product.

8 A method for applying game theory to a commercial website, including:
providing a website for the sale of at least one product;
displaying an initial price for said at least one product;
allowing a consumer to express interest in purchasing said at least one product, wherein the price of said at least one product drops by a predetermined and advertised amount when said consumer expresses interest in purchasing said at least one product;
allowing an in-opted consumer to purchase said at least one product, wherein the price of said at least one product increases by a predetermined and advertised amount when said consumer purchases said at least one product on said website;
modifying the displayed price of said at least one product as a function of the number of consumers expressing interesting in said at least one product and the number of consumers actually purchasing said at least one product;
displaying a current price of said at least one product as function of said modifying; and,
allowing continued expression of interest and buying of said product.

9. The method according to claim 8, wherein the dollar money amount that said price of said at least one product drops when said consumer expresses interest in purchasing said at least one product is less than the increase in said price when said consumer actually purchases said at least one product.

10. The method according to claim 8, further including the step of suggesting to said consumer to view a commercial, wherein viewing of said commercial further reduces said price of said at least one product.

11. The method according to claim 8, wherein said at least one product is a plurality of distinct products.

12. The method according to claim 11, wherein said plurality of products is selected from the fields of consumer electronics, clothing, music, travel, recreation, transportation and entertainment.

13. A method for determining the optimal price of a product, including the following:
providing a website where a consumer may purchase said product;
assigning an initial price to said product;
reducing the price of said product by a predetermined and advertised amount for each consumer that expresses interest on said website for purchasing said product;
selling said product when a consumer commences a purchase of said product on said website;
raising the price of said product by a predetermined and advertised amount with said purchase of said product;
modifying the price of said product, wherein each purchase of said product raises the price of said product, while expression of interest in said product by new consumers leads to a reduction of the price of said product; and,
selling additional units of said product, each unit sold at a current price determined by initial price, number of people expressing interesting in said product, and number of people actually having bought said product.

14. The method according to claim 13, wherein a plurality of consumers can purchase a plurality of units of said product.

15. The method according to claim 13, wherein said predetermined and advertised amount in price reduction is ten cents.

16. The method according to claim 13, wherein said predetermined and advertised amount in price increase is $1.

17. The method according to claim 13, further including the step of suggesting to said consumer to watch a video commercial in exchange for further reducing the price of said product.

18. The method according to claim 17, wherein said commercial is related to said product.

19. The method according to claim 13, wherein said product is a consumer product.

20. The method according to claim 13, further including the step of alerting a consumer as to the price of said product.

21. The method according to claim 20, wherein said alert is delivered to said consumer by phone, SMS, instant messaging, electronic mail or other form of communication.

22. A method for providing a private sale of a product, including the following:
allowing a user to choose a product which he/she wishes to purchase;
beginning a sale of said product to said user at a predetermined price for said product;
providing instructions to said user as to how he/she can reduce the price of said product through his/her actions and/or the actions of others;
allowing said user and said others to perform said actions, wherein the performance of said actions reduces the price of said product; and,
selling said product to said user either at the end of a predetermined period of time or at a time when said user indicates that he/she wishes to purchase said product at a known current price.

23. The method according to claim 22, wherein said instructions include viewing of an online advertisement or responding to an online questionnaire.

24. The method according claim 22, wherein said product is selected from the fields of consumer electronics, clothing, music, travel, recreation, transportation, food and entertainment.

25. The method according to claim 22, wherein said private sale is conducted in conjunction with a social network website.

26. The method according to claim 23, wherein people associated with said user follow said instructions in order to reduce the price of said product.

27. The method according to claim 22, wherein said price of said product reaches zero dollars.

28. The method according to claim 25, wherein said private sale is accessible only to said user and to individuals associated with said user.

29. The method according to claim 22, wherein said product is a plurality of identical or different products.

30. The method according to claim 22, wherein said private sale is a plurality of private sales.

31. A method for using a social network to reduce the price of a product, including:
providing a website where said product can be purchased;
allowing a user of said website to purchase said product;
informing said user that said website will not charge said user for the purchase of said product for a given period of time;
instructing said user as to activities that, if performed, would allow for a lowering of the price of said product, the more activities performed the greater the discount in the price of said product;
allowing said user to perform said activities and encourage his/her friends and acquaintances to perform the same said activities; and,
charging said user for said product after said period of time, the final price being the original price for said product less any amounts accrued through the performance of said activities.

32. The method according to claim 31, wherein said activities include viewing of an advertisement, providing personal information, filling out a questionnaire, rating a product, and performing a specific task.

33. The method according to claim 31, wherein said friends and acquaintances are associated with said user via a social network.

34. The method according to claim 22 wherein said actions are selected from the activities of watching advertisements, responding to questions, joining a group, providing information, rating products, going to one or a plurality of websites, performing activities on one or a plurality of websites, downloading or uploading information, filling out questionnaires, recruiting new users, or doing a combination of different activities.

34. A method for determining the optimal price of a product, including the following:
providing a website where a consumer may purchase said product;
assigning an initial price to said product;
reducing the price of said product by a predetermined and advertised amount for each consumer that expresses interest on said website for purchasing said product;
selling said product when a consumer commences a purchase of said product on said website;
raising the price of said product by a predetermined and advertised amount with said purchase of said product;
modifying the price of said product, wherein each purchase of said product raises the price of said product, while expression of interest in said product by new consumers leads to a reduction of the price of said product;
selling additional units of said product, each unit sold at a current price determined by initial price, number of people expressing interesting in said product, and number of people actually having bought said product; and,
halting sales of said product when profit per unit falls to a predetermined cutoff level.

35. The method according to claim 34, wherein a plurality of consumers can purchase a plurality of units of said product.

36. The method according to claim 34, wherein said predetermined cutoff level is $50 per unit.

37. The method according to claim 34, wherein said predetermined and advertised amount in raised price is $10.

38. The method according to claim 34, further including the step of suggesting to said consumer to watch a video commercial in exchange for further reducing the price of said product.

39. The method according to claim 38, wherein said commercial is related to said product.

40. The method according to claim 39, wherein said product is a consumer product.

41. The method according to claim 34, further including the step of alerting a consumer as to the price of said product.

42. The method according to claim 41, wherein said alert is delivered to said consumer by phone, SMS, instant messaging, electronic mail or other form of communication.

43. A method for determining the optimal price of a product, including the following:
providing a website where a consumer may purchase said product;
assigning an initial price to said product;
reducing the price of said product by a predetermined and advertised amount for each consumer that expresses interest on said website for purchasing said product;
selling said product when a consumer commences a purchase of said product on said website;
raising the price of said product by a predetermined and advertised amount with said purchase of said product;
modifying the price of said product, wherein each purchase of said product raises the price of said product, while expression of interest in said product by new consumers leads to a reduction of the price of said product;
selling additional units of said product, each unit sold at a current price determined by initial price, number of people expressing interesting in said product, and number of people actually having bought said product; and,
returning price of product to a value above cost of product when profit per unit falls to a predetermined cutoff level.
